(19) United States
(12) Patent Application Publication
(10) Pub. No.: US 2002/0054583 A1
(43) Pub. Date: May 9, 2002

(54) Automatic gain control for a time division duplex receiver

(75) Inventors: Robert L. Olesen, Huntington, NY (US); Timothy A. Axness, Collegeville, PA (US); Leonid Kazakevich, Planinview, NY (US)

Correspondence Address: VOLPE AND KOENIG, PC, DEPT ICC, SUITE 400, ONE PENN CENTER, 1617 JOHN F. KENNEDY BOULEVARD, PHILADELPHIA, PA, 19103, US

(73) Assignee: InterDigital Technology Corporation, Wilmington, DE

(21) Appl. No.: 09/974,273

(22) Filed: Oct. 10, 2001

Related U.S. Application Data
(60) Provisional application No. 60/238,907, filed on Oct. 10, 2000.

(51) Int. Cl. H04L 12/26

(52) U.S. Cl. 370/336; 370/252

(57) ABSTRACT

A method and system for automatic gain control (AGC) in a TDD communication system, wherein each time slot of the communication signal contains a preamble in binary phase shift keying (BPSK) format, located at the beginning of the time slot. The channel estimation by the receiver is improved since the preamble allows AGC to quickly estimate the signal strength and adjust the gain accordingly. This permits all data symbols within the data burst, which follows the preamble, to be correctly received, and results in a midamble channel estimate that is much more accurate. It also allows the AGC circuit within the TDD receiver to be greatly simplified.

### CROSS REFERENCE TO RELATED APPLICATIONS

This application claims priority from Provisional Patent Application No. 60/238,907, filed on Oct. 10, 2000.

### BACKGROUND

The invention generally relates to wireless communication systems. In particular, the invention relates to an improved automatic gain control (AGC) circuit for a time division duplex (TDD), time division multiple access (TDMA) or time division-code division multiple access (TD-CDMA) receiver. For simplicity, the receiver shall be referred to as TDD throughout.

It is well known in the art that power varies significantly between adjacent time slots in a TDD frame, due to variable data rates or variable number of active users in a time slot. In order to determine the correct AGC gain, the AGC circuit estimates symbol power of the first N symbols as they are received. During this estimation process, the symbols may be lost for data estimation due to imperfect gain control during this time. Depending on the initial accuracy of the gain estimate, this estimation procedure may take a long time.

A typical TDD frame generally comprises fifteen time slots. Each of the time slots comprises two data bursts, that are separated by a midamble, followed by a guard period which forms the end of the frame. The data bursts transmit the desired data, and the midamble is used to perform channel estimation. Since the midamble is used to perform channel estimation, gain must be constant over the entire time slot in order to get an accurate estimation of the channel.

Prior art AGC methods have drawbacks. Since both the number of codes and their relative power in the received TDD frame is unknown, the AGC circuit takes unnecessarily long to adjust to the correct level of gain. To determine the estimated symbols, the receiver receives a time slot's worth of data and performs a channel estimation based on the midamble. The channel estimation assumes there is a constant gain and that the power of the symbols is known for the duration of the estimation process. Interference with channel estimation can occur if the AGC is active during the midamble or either data burst. If the first few data symbols have a signal strength that is significantly less than the remainder of the symbols in the TDD frame, these data symbols may not be properly received due to the weakness of the symbols. Accordingly, channel estimation under this prior art AGC method ultimately results in a channel estimation that is slow and not very accurate.

### SUMMARY

The present invention is an enhanced TDD frame structure which includes a preamble for gain estimation, and includes a method and apparatus for using this enhanced TDD frame. The preamble enables the AGC circuit to quickly estimate the power level of the received signal and to adjust the gain level accordingly. This permits all data symbols within the data burst to be correctly received, and results in a midamble channel estimate that is much more accurate. It also allows the AGC circuit within the TDD receiver to be greatly simplified. Further improvements are afforded by utilizing a preamble having a binary phase shift keying (BPSK) format.

### BRIEF DESCRIPTION OF THE DRAWINGS

FIG. 1 is an illustration of an enhanced TDD communication burst with a preamble.

FIG. 2 shows a block diagram of an AGC circuit that processes the communication burst of FIG. 1.

FIG. 3 shows a method flowchart for channel estimation using the circuit of FIG. 2.

### DETAILED DESCRIPTION OF THE PREFERRED EMBODIMENTS

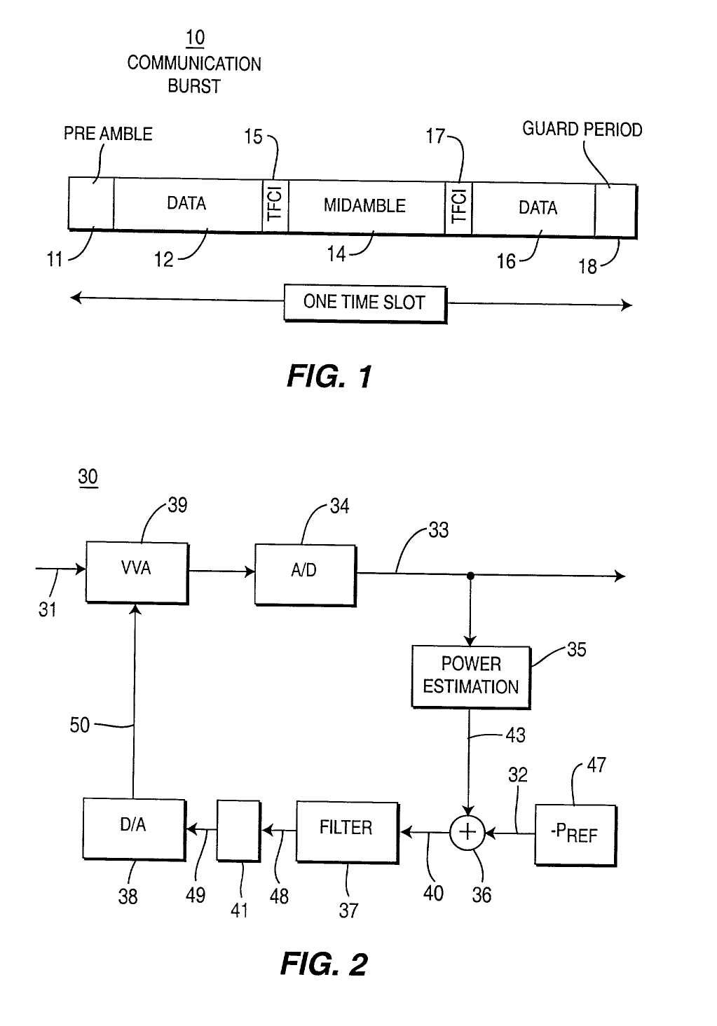

FIG. 1 shows an improved TDD communication burst 10 having a preamble 11, two data bursts 12, 16, a midamble 14, two transport format combination indicator (TFCI) periods 15, 17 and a guard period 18. As shown, the communication burst 10 comprises one time slot of the TDD signal architecture. The two data bursts 12, 16 are separated by the midamble 14 and the two TFCI periods 15, 17.

Each portion of the TDD communication burst 10 supports a different function. The midamble 14 facilitates estimation of the transmitter channel. The two data bursts 12, 16 comprise the data carrying portion of the communication burst 10, and are used to transport the desired data. Administrative functions of the communication system are handled using transport sets. The TFCI periods 15, 17 store the information bits associated with these transport sets and instruct the receiver as to how the data is partitioned within the communication burst 10. The guard period 18 is void of information and is provided as a demarcation gap between consecutive time slots.

In accordance with the present invention, the preamble 11 comprises one or more symbols. Preferably the preamble 11 is in binary phase shift keying (BPSK) format, although this is not required. A BPSK symbol format is preferably used since power estimation can be simply determined by squaring the BPSK signal. The remainder of the communication burst 10 is formatted as a quadrature phase shift keying (QPSK) signal. The inclusion of the preamble 11 allows for an easier estimation of the power level of the signal. The preamble 11 is preferably a pseudo-random sequence, randomly generated and then maintained as a fixed sequence. Since the pseudo-random sequence is the same for every time slot, synchronization is simplified by requiring only a single correlator for the system. A pseudo-random signal also provides for maximum spreading, thereby avoiding a concentrating of power which is unfavorable. In addition, using a pseudo-random signal allows for the elimination of a DC bias in the signal.

FIG. 2 shows a simplified automatic gain control (AGC) circuit made in accordance with the present invention, which takes advantage of the preamble 11. The AGC circuit 30 comprises a voltage variable attenuator (VVA) 39, an analog-to-digital (A/D) converter 34, a switch 41, a power estimation unit 35, a power reference 47, a summer 36, a feedback filter 37, and a digital-to-analog (D/A) converter 38. The switch 41, power estimation unit 35, power reference 32, summer 36, feedback filter 37 and D/A converter 38 together form a feedback loop 43.

The VVA 39 is a standard electronic device used in AGC circuits for receiving an input signal and adjusting the amplifier gain to maintain a constant output signal level for further receiver processing. The A/D converter 34 accepts the analog signal output from the VVA 39 and outputs a digital signal 33. The power estimation unit 35 accepts the digital signal 33 and mathematically processes the digital signal with a predetermined algorithm to average the power level of the sequence of symbols that form the communication burst 10. Preferably, the power is estimated using the following formula:

$${P}_{est} = \frac{1}{N} {\sum }_{J = 1}^{N} {I}_{J}^{2} + {Q}_{J}^{2} \qquad Equation ( 1 )$$

This average power level is provided to the first input of the summer 36 as a power estimation signal 43. The summer 36 performs a simple sum of the two signal inputs: 1) the power estimation signal 43 output from the power estimation unit 35; and 2) the power reference signal 32 output from the power reference unit 47. Since the power reference signal 32 output from the power reference unit 47 is preferably a negative signal, the power reference signal 32 is essentially subtracted from power estimation signal 43 to generate an error signal 40. The error signal 40 is then input to the feedback filter 37. The feedback filter 37 is an integrator, or alternatively, a low pass filter. The feedback filter 37 sets the time constant of the feedback loop to ensure stability and smooth out variations of the error signal 40. The filtered output signal 48 is input into the switch 41.

The switch 41 determines whether the filtered output signal 48 is within a predetermined tolerance threshold. If so, the switch 41 holds the filtered output signal 48, thereby maintaining a switch output signal 49 at the same level as the filtered output signal 48 when the switch was opened. If the filtered output signal 48 is not within the predetermined tolerance threshold, the filtered output signal 48 is permitted by switch 41 to fluctuate from the previous pass through the feedback filter 37. The switch output signal 49 is then converted to an analog signal 50 by the D/A converter 38, and this analog signal 50 is used as a control signal to adjust the gain of the VVA 39. The A/D and D/A converters 34, 38 are well known and widely used in the art and need not be described in detail herein.

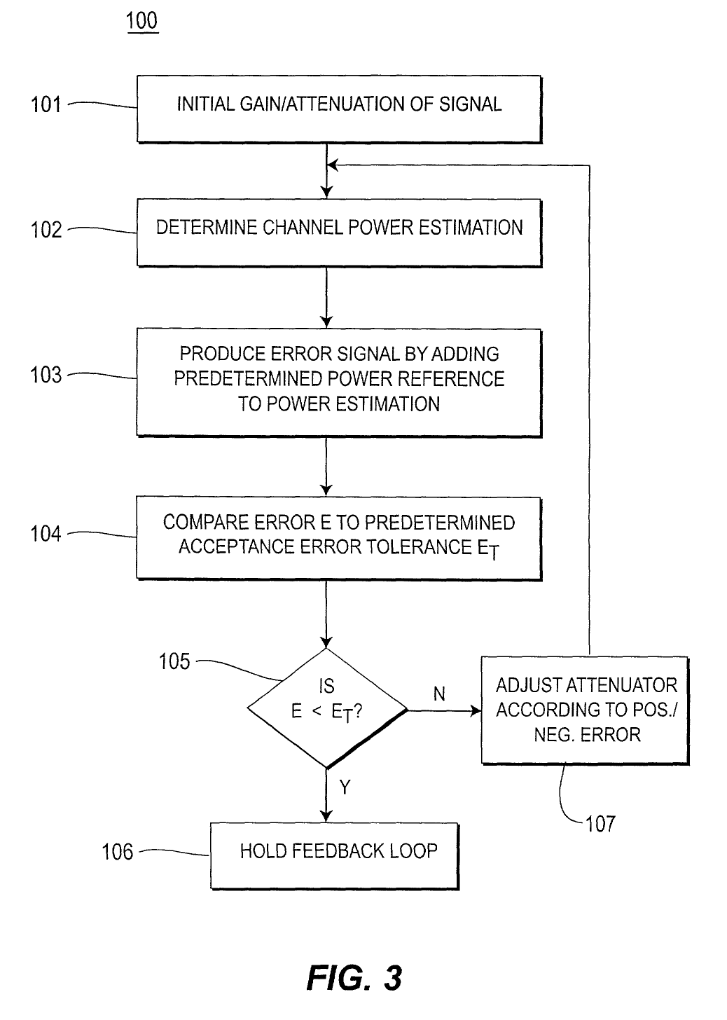

Referring to FIG. 3, a preferred method 100 in accordance with the present invention is shown. The method is initiated when the communication burst 31 initially passes through the VVA 39 in step 101 and is then digitally converted by the A/D converter 34. The digital signal 33 enters the feedback loop 43 and is next processed by the power estimation unit 35 in step 102. The negative predetermined power reference signal 32 is added to the power estimate at summer 36, resulting in an error signal 40 (step 103). The error signal 40 is averaged by the feedback filter 37 (step 104). A decision step 105 is performed to determine whether the error signal 40 is low enough (i.e. lower than a threshold) to complete the channel estimation process. If the error signal 40 is less than the error threshold, the channel estimation process is complete, and the feedback loop 43 is set by switch 41 to hold the VVA 39 control signal constant (step 106) for the remainder of the time slot.

However, if the error signal 40 is greater than the tolerance, the control signal from the filter 37 is converted by the D/A converter 38 and is used as a control signal to the VVA 39 (step 107), and the channel estimation is repeated. The power estimation and attenuation adjustment process may be repeated for a second symbol of the preamble, or more, until the error is reduced to an acceptable level and the switch 41 is activated. The attenuation provided by the VVA 39 is then fixed for the remainder of the time slot (step 106). This process is preferably repeated for each time slot.

One advantage of using the preamble in accordance with the present invention, with respect to hardware, is in reducing the required size of the A/D converter 34. A typical size for A/D converter 34 in accordance with the present invention is six (6) to ten (10) bits, depending on requirements.

What is claimed is:

1. A TDD wireless communication system, wherein a communication signal is divided into consecutive time slots, each time slot subdivided into sections comprising:
a preamble, in binary phase shift keying (BPSK) format, located at the beginning of the time slot;
a midamble at the center of the time slot;
a pair of data packets;
two transport format combination indication (TFCI) sections, each positioned between the midamble and one of the data packets; and
a guard period located at the end of the time slot.

2. The system of claim 1 wherein the preamble is pseudo-random and is the same sequence for every time slot.

3. A method for automatic gain control (AGC) in a TDD communication system, wherein each time slot of the communication signal contains a BPSK preamble, the method comprising:
estimating the signal;
comparing the signal with a predetermined power reference;
calculating an error signal based on the comparison; and
adjusting the attenuation of the communication signal.

4. The method of claim 3 wherein the preamble is pseudo-random and is the same sequence for every time slot.
